(19) United States
(12) Patent Application Publication
(10) Pub. No.: US 2005/0212233 A1
(43) Pub. Date: Sep. 29, 2005

(54) Nestable cart

(76) Inventor: Donald M. Hall, Mt. Sinai, NY (US)

Correspondence Address: SHLESINGER, ARKWRIGHT & GARVEY LLP;Suite 600, 1420 King Street, Alexandria, VA, 22314, US

(21) Appl. No.: 10/968,972

(22) Filed: Oct. 21, 2004

Related U.S. Application Data
(63) Continuation-in-part of application No. 10/961,194, filed on Oct. 12, 2004.
(63) Continuation-in-part of application No. 10/836,401, filed on May 3, 2004.
(60) Provisional application No. 60/509,805, filed on Oct. 10, 2003.
(60) Provisional application No. 60/512,772, filed on Oct. 21, 2003.

(51) Int. Cl. B62D 39/00

(52) U.S. Cl. 280/33.991

(57) ABSTRACT

Nestable cart includes a top, a bottom spaced apart from the top, and left and right sides extending between the top and the bottom. The bottom may be configured for moving upwardly relative to a rear of the cart, so that the bottom is movable between a horizontally extended use or non-nesting position and a somewhat vertically extending non-use or nesting position. When the bottom is in its nesting position, a further cart may be inserted into a front of the cart for being nested substantially within the cart. The cart and the further cart may be configured for nesting together without interfering with each other.

### CROSS-REFERENCE TO RELATED APPLICATIONS

This application is a continuation-in-part of application Ser. No. 10/961,194, filed Oct. 12, 2004, which claims the priority of application No. 60/509,805, filed Oct. 10, 2003; and this application claims the priority of application No. 60/512,772, filed Oct. 21, 2003; and this application is a continuation-in-part of application Ser. No. 10/836,401, filed May 3, 2004, and each of which is incorporated herein by reference.

### FIELD OF THE INVENTION

The invention relates to carts. More particularly, the invention relates to carts which may be nested within one another in order to reduce the amount of floor space required to store the carts when not in use. Even more particularly, the invention relates to nestable carts particularly suited for use in the food processing, storage, and sales industries.

### BACKGROUND OF THE INVENTION

Carts are known, yet there remains a need for carts requiring less space than known carts.

Known carts require large amounts of floor space, as well as large volume requirements when not in use.

Known patents in the name of Donald M. Hall, some of which are directed to reducing floor space and volume requirements of devices when in use and not in use, include:
Des. 480,528
U.S. Pat. No. 6,474,757
U.S. Pat. No. 6,419,098
U.S. Pat. No. 6,366,313
U.S. Pat. No. 6,322,180
U.S. Pat. No. 6,149,120
U.S. Pat. No. 6,131,399
U.S. Pat. No. 6,062,401
U.S. Pat. No. 5,957,309
U.S. Pat. No. 5,953,871
U.S. Pat. No. 5,628,522
U.S. Pat. No. 5,503,087
U.S. Pat. No. 5,483,782
U.S. Pat. No. 5,471,922
U.S. Pat. No. 5,456,191
U.S. Pat. No. 5,386,787
U.S. Pat. No. 5,330,064

Additional known U.S. patents include:
U.S. Pat. No. 4,784,446 to Newhouse;
U.S. Pat. No. 6,209,977 to Vondrejs;
U.S. Pat. No. 5,507,570 to Williams;
U.S. Pat. No. 4,893,885 to Borello;
U.S. Pat. No. 4,491,375 to Ugalde;
U.S. Pat. No. 5,927,837 to Schmidt;
U.S. Pat. No. 3,861,702 to Wilson;
U.S. Pat. No. 2,992,010 to Sides;
U.S. Pat. No. 2,928,681 to Wilson;
U.S. Pat. No. 3,977,689 to Rosa;
U.S. Pat. No. 3,920,258 to Lundstrom;
U.S. Pat. No. 3,874,689 to Morgan;
U.S. Pat. No. 3,861,768 to Wilson; and
U.S. Pat. No. 3,840,242 to Craig.

There is a need for a cart which reduces space requirements.

### OBJECTS AND SUMMARY OF THE INVENTION

Accordingly, it is an object of the invention to provide a cart that overcomes any drawbacks and disadvantages of known carts.

Another object of the invention is to provide a cart which can be shipped in a space-saving manner, stored in space-saving manner, and used in a space-saving manner by the end user.

Another object of the invention is to provide a cart which can be readily nested within one or more carts when not in use.

Yet another object of the invention is to provide a cart which can be readily opened and closed for access to products supported within the cart.

A still further object of the invention is to provide a cart having one or more doors, sides, top(s) or bottom(s) which can be secured in a non-use position.

Another object of the invention is to provide a substantially rectangular, square, or trapezoidal cart, as viewed from above, or below, which reduces storage requirements, while maintaining the benefits of conventional rectangular or square carts.

Another object of the invention is to provide an inverted U-shaped, V-shaped, or C-shaped cart, when viewed from the front, for example.

Another object of the invention is to provide an inner cart having wheels which do not engage an outer cart when the inner cart is nested within the outer cart.

In summary, the invention is directed to a nestable cart requiring less storage space than known carts.

The inventive cart may include a top, a side extending outwardly away from the top, and a bottom extending outwardly away from the side. The bottom may be spaced apart from the top. The bottom may be movable between a nesting position extending substantially along the side to a non-nesting position.

The nesting position may be a position adjacent the top.

The non-nesting or use position may be a position located at a distance from the top or at a position extending away from the side.

The inventive cart may likewise include a left and right side, and the bottom may be movable between a use position extending between the left and right sides to an open position extending substantially along or adjacent to one of the left and right sides.

The left and right sides may be sized so that when the bottom is in its nesting position, then a further cart may be nested within the cart, and a still further cart may be nested within the further cart, and so forth with successively smaller further carts or cabinets.

A cart may include a bottom hingedly attached to the left, right, or side rear.

A cart may include a bottom which includes a first part and a second part. The first part may be hingedly attached to a left side, and the second part may be hingedly attached to the right side. The first part of the bottom may extend along the left side and the second part of the bottom may extend along the right side in their respective nesting positions. Such construction of a bottom having first and second parts such as first and second halves, allows for a cart having a relatively low and wide configuration, for example.

A cart may include that the bottom is slidably attached to the side or the rear.

A cart may include that a securing element is provided to secure the bottom to one or more of the side and rear when the bottom is in its nesting position.

A cart may include that an engagement element is provided for detachably engaging the bottom in its use or non-nesting position.

A cart may include that an engagement element is provided for detachably engaging the bottom in its nesting position.

A cart may include that the engagement element is provided on the rear.

A cart may include that a mechanical assist, such as a gas piston is provided to assist in moving the bottom from its non-nesting to its nesting position, for example.

A cart may include that a roller is provided for movably supporting the cart on a surface.

A cart may include that a runner is provided on one or more of sides, the runner being configured for supporting a tray.

A cart may include that at least one of the sides includes an insulating panel.

A cart may include that an airflow passage is provided adjacent at least one of the sides, the airflow passage being configured for enhancing air flow from a lower portion to an upper portion of the at least one of the sides.

A cart may include that a retractable shelf is provided for increasing the surface area, as viewed from above.

It should be noted that relative terms such as up, down, left, right, top, and bottom are for convenience only and for ease of understanding, and are not intended to be limiting.

### BRIEF DESCRIPTION OF THE DRAWINGS

FIG. 1 is a top perspective view of a nestable cart or cart system according to the invention when one cart is moved into, or out of, a nesting condition with another cart;

FIG. 2 is a top perspective view of a cart of FIG. 1;

FIG. 3 is a top plan view of a cart of FIG. 1; and

FIG. 4 is a schematic side view of a further outer cart according to the invention.

### DETAILED DESCRIPTION OF THE INVENTION

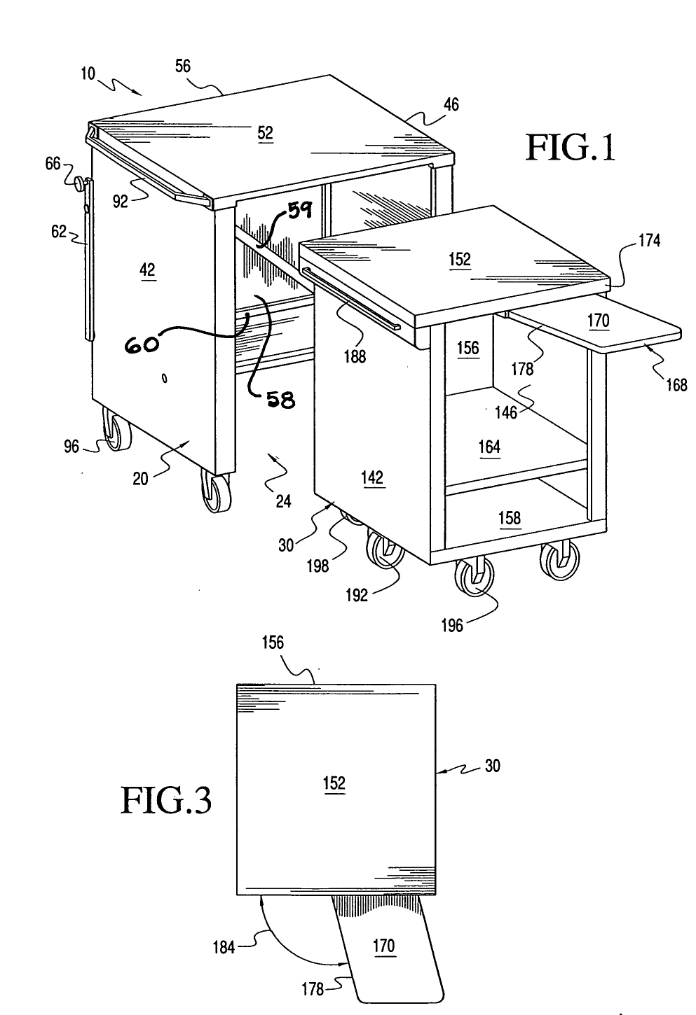

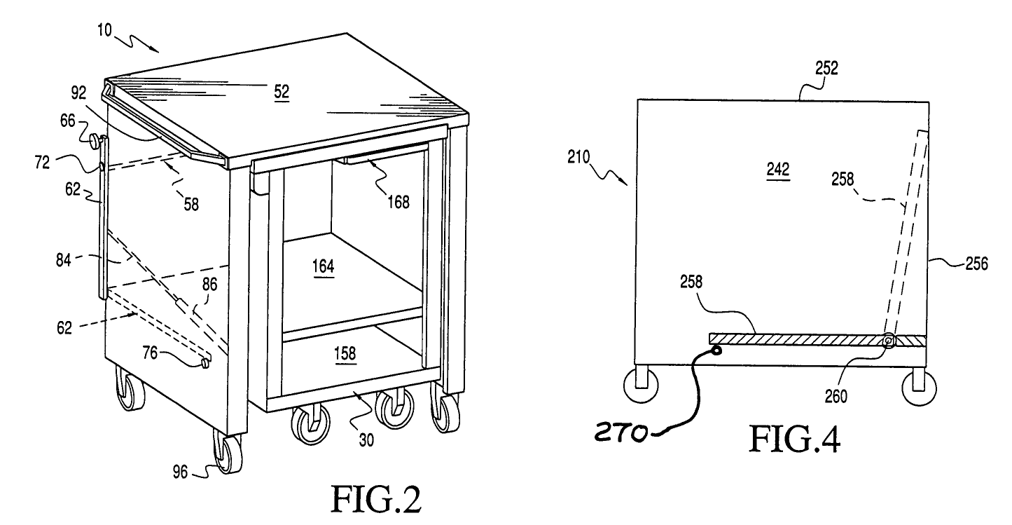

FIGS. 1-4 illustrate a nesting cart or cart system 10 according to the invention.

Cart system 10 may include an outer cart 20 defining an opening or interior 24 configured for receiving an inner cart 30.

Outer cart 20 may include a first or left side 42 and a second or right side 46. There may likewise be a top 52 and a rear or rear side 56. Further, a bottom or bottom shelf 58 may be provided that extends at least partially across the interior of outer cart 20. Bottom 58 may be hingedly or pivotably or otherwise movably attached to a portion of outer cart 20. A strengthening element 59, such as a crossbrace, may be provided on bottom 58. A pivot 60 may provide the hinged attachment between bottom 58 and the remainder of cart 20.

An actuator or handle 62 may be provided for moving bottom shelf 58 between a use or non-nesting position and a non-use or nesting position. A knob 66 may be provided to assist a user in moving handle 62. Knob 66 may likewise function to withdraw a release pin or actuator for releasing engagement between handle 62 and outer cart 20. Alternatively, a release pin or actuator 72 could be used in addition to a fixed knob 66 for detachably engaging handle 62 with the remainder of outer cart 20.

A catch or engagement element 76 may be provided for limiting downward movement of handle 62 and, hence, bottom 58.

A mechanical assist 80 may be provided to assist in the raising (or lowering) of bottom 58. Mechanical assist 80 may include a piston 84 and a cylinder 86 of a gas cylinder assembly, for example.

A handle 92 may be provided at one or more locations on outer cart 20 to assist in moving cart 20 from one location to another. Likewise, one or more wheels or roller 96 may be provided in the case where outer cart 20 is to be readily moved.

Inner or further cart 30 may be configured and sized to nest within interior 24 of outer cart 20 when bottom 58 of outer cart 20 is in its raised or non-use or nesting position.

Inner cart 30 may include a left side 142, a right side 146, and a top or top side 152.

A rear or rear side 156 may likewise be provided, as well as a bottom or bottom shelf 158, and a second or further or upper shelf or bottom 164.

An optional slidable or slide-out shelf 168 may be provided that includes an upper surface 170. Upper surface 170 may be configured for providing an additional storage area or work surface, for example.

Shelf 168 may be configured as a square, rectangle, trapezoid, or rhombus, for example as shown in FIG. 3. A front edge 174 of top 152 and a left face 178 of shelf 170 may extend at an angle 184 relative to each other. The size of angle 184 may be varied depending on the intended use. As shown in FIG. 3, in the case where a user stands between or facing edge 174 and left face 178, as angle 184 is increased, the space available for the user increases.

A handle 188 may be provided at one or more locations on inner cart 30 to assist in handling or moving cart 30.

One or more side wheels 192 may be provided on cart 30, such as on bottom 158. One or more front wheels 196, and one or more rear wheels 198 may likewise be provided. As shown in FIG. 1, six wheels may be provided; i.e. wheel 192 under a left portion of cart 30, two wheels 198 under a rear portion, a right wheel 198 under a right portion, and two wheels 196 under a front portion.

One or more of wheels 192 and/or 198 may be configured and located for avoiding interference between wheels 192, 198, and the sides or wheels 92 of outer cart 20 when nesting cart 20 and 30. Still further, wheel 192, 198, and/or wheels 96 of outer cart 20 may be configured and located for avoiding interference with each other when nesting, or being moved in a nested condition, or both. Such may be the case when wheels or swivel casters or a combination of wheels and swivel casters is used.

In some instances it may be desirable to use different wheel/caster sizes or heights to avoid such interference when nesting carts, or when carts are being moved together in a nested condition, for example.

Depending on the intended use, the optimizing of the sizing of the inner cart 30 relative to outer cart 20, while obtaining the largest wheel footprint for each of the carts, may be a consideration.

There may be applications for which non-swiveling casters are suited.

FIG. 4 illustrates schematically a side view of a portion of a further outer cart 210 according to the invention.

Cart 210 may include a side wall 242, a top 252, a rear 256, and a bottom or bottom shelf 258. Bottom shelf 258 has no handle as in the cart of FIG. 1, bottom shelf 258 being pivotably attached at a pivot point or hinge 260 provided on a portion of cart 210. Pivot point 260 may be located and configured so that when the bottom shelf 258 is moved from its solid line use or non-nesting position shown in FIG. 4 to its phantom line non-use or nesting position 258 leaning against rear 256, the angle and disposition of bottom 258 in its non-use or nesting position leaning against rear 256 is selected so that the force of gravity assists in retaining shelf 258 in its nesting position. In the phantom line nesting position of shelf 258, an inner cart may be nested in cart 210, as in the cart system of FIG. 1.

A stop 270 may be provided on side wall 242 forwardly of pivot 260. Stop 270 may be sized and located to carry a maximum share of forces exerted on shelf 258, for example, to minimize the share of forces exerted on pivot 260, in use, depending on the physical requirements of pivot 260 and the expected operating conditions. An opposed side wall, additional stop or stops may be provided, as well as other features set forth elsewhere in the description, as will be appreciated.

One or more runners or L-shaped or otherwise shaped members may be provided in the interior of the cart, for example. Runners may be useful when the cart is used for supporting elements to be at least temporarily stored and slidably supported on such runners, for example. Such stored elements may include trays as used in the food industry, which trays support loaves of bread, other baked goods, foodstuffs, and other objects, depending on the trade. The cart when so configured may be considered to be a rack, for example. Examples of substantially open racks may be seen in ones of the above-listed Donald M. Hall patents.

The cart may include a bottom shelf having a left half or left part and a right part. In that manner, the top may be used in a location where the interior height of the cart is lower than is required for using a container of equal interior height having a single bottom shelf, as described above in connection with FIG. 1.

It is further contemplated that the bottom or bottom shelf, as well as one or more of the front, sides, and top, may be slidably secured in a holder or groove provided in the remainder of the cart, for example. In such a case, the removable bottom, for example, could be slid out of engagement with the remainder of the cart when not in use, and then slid into engagement with another portion of the cart, such as in a position extending substantially parallel to one of the sides, front, rear or top.

The illustrated dimensions on the carts are provided by way of example and are not intended to be limiting.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the claims set forth herein.

1. A nestable cart, comprising:
a) a top;
b) a bottom spaced apart from the top;
c) a left side disposed between and connecting the top and the bottom;
d) the bottom being movably connected to a portion of the cart, the bottom being movable between a nesting position and a non-nesting position; and
e) in the nesting position the bottom being located adjacent the top, and in the non-nesting position the bottom being located at a distance from the top.

2. A cart as in claim 1, wherein:
a) a right side is disposed between and connects the top and the bottom, the right side being spaced apart from the left side; and
b) the left and right sides are sized so that when the bottom is in its nesting position, then a further cart may be nested within the cart, the cart and the further cart being nested together in a smaller volume than a volume defined by the cart and a further cart located unnested side by side.

3. A cart as in claim 1, wherein:
a) a rear is provided;
b) the bottom is hingedly attached to the rear side; and
c) in the nesting position the bottom extends along the rear.

4. A cart as in claim 1, wherein:
a) the bottom is slidably attached to the left side.

5. A cart as in claim 1 wherein:
a) a securing element is provided to secure the bottom to the left side when the bottom is in its non-nesting position.

6. A cart as in claim 1, wherein:
a) an engagement element is provided for detachably engaging the bottom in its nesting position.

7. A cart as in claim 6, wherein:
a) the engagement element is provided adjacent the top.

8. A cart as in claim 1, wherein:
a) a roller is provided for movably supporting the cart on a surface.

9. A cart as in claim 1, wherein:
a) the left side includes an insulating panel.

10. A cart as in claim 1, wherein:
a) an air flow passage is provided adjacent the left side, the air flow passage being configured for enhancing air flow from a lower to an upper portion of the left side.

11. A cart as in claim 1, wherein:
a) an assist is provided on the cart for assisting in raising the bottom.

12. A cart as in claim 1, wherein:
a) an assist is provided on the cart for assisting in lowering the bottom.

13. A cart as in claim 11, wherein:
a) the assist includes a piston.

14. A cart as in claim 13, wherein:
a) the piston includes a gas-filled piston.

15. A cart as in claim 1, wherein:
a) an extendable shelf is provided on the cart.

16. A cart as in claim 15, wherein:
a) the extendable shelf is located adjacent the top.

17. A cart as in claim 15, wherein:
a) the shelf includes a front face, the front face extending at an angle relative to a front of the cart that is greater than 90°.

18. A cart as in claim 1, wherein:
a) a wheel is provided on a lower portion of the cart for supporting the cart on a surface, the wheel being located so that, in use, when the bottom is in its nesting position, and a further cart is inserted into a front portion of the cart, a lower wheel on a further cart is insertable without interference between the wheel on the cart and the further wheel on the further cart.

19. A cart as in claim 1, wherein:
a) the bottom is movably attached to a rear portion of the cart for moving between the non-nesting position and the nesting position; and
b) the bottom extends away from the rear portion of the cart when the bottom is in its nesting position and in its non-nesting position.

20. A cart as in claim 19, wherein:
a) a pivot connection is provided between the bottom and the rear portion of the cart, the bottom being pivotably attached to the rear portion; and
b) the pivot connection being spaced sufficiently away from the rear portion of the cart so that when the bottom is in its nesting position, the bottom extends upwardly and sufficiently rearwardly away from a front portion of the cart, so that the bottom remains in its nesting position owing to the force of gravity.
